(19) United States
(12) Patent Application Publication
(10) Pub. No.: US 2014/0325151 A1
(43) Pub. Date: Oct. 30, 2014

(54) METHOD AND SYSTEM FOR DYNAMICALLY MANAGING BIG DATA IN HIERARCHICAL CLOUD STORAGE CLASSES TO IMPROVE DATA STORING AND PROCESSING COST EFFICIENCY

(71) Applicant: XEROX CORPORATION, Norwalk, CT (US)

(72) Inventors: Hyun Joo Kim, Monmouth Junction, NJ (US); Gueyoung Jung, Rochester, NY (US)

(73) Assignee: Xerox Corporation, Norwalk, CT (US)

(21) Appl. No.: 13/870,165

(22) Filed: Apr. 25, 2013

(51) Int. Cl. G06F 3/06

(52) U.S. Cl. CPC G06F 3/065; G06F 3/0604; G06F 3/0683
USPC 711/117

(57) ABSTRACT

A system and method for autonomic data storage and movement for big data analytics. A cost, such as storing cost and a processing cost are calculated for received data. The processing type associated with the received data is determined in response to the calculated costs. The received data is classified as one of a set of hierarchical storage classes based upon the determined processing type. The hierarchical storage classes include no data store, memory, HDFS, database, disk archive, external clouds, and data removal. The received data is then stored in the storage location associated with that class. In the event that insufficient capacity is available in the location, the priority of the received data and the priority of previously stored data is determined and compared. The priority is calculated based on potential usage, privacy, estimated cost, frequency of usages and the age of data. The lower priority data is then moved to the next lower hierarchical class for storage.

### BACKGROUND

The subject disclosure is directed to the data management arts, data storage arts, data analytics arts, cloud computing arts, and the like.

As a large amount of data keeps being generated in a short time and is necessary to be processed on-demand for big data analytics, it becomes a critical issue to manage the increasing big data efficiently. An analytics platform can integrate various heterogeneous classes of cloud storage systems, such as memory, database, Hadoop file system (HDFS), traditional disk of internal data center, and external cloud storages. It is not trivial to choose a class of such storage systems for various analytics services because each storage class has different characteristics such as the format of data management, cost of placement or replication, applicable operations, etc. and each analytic service may require different types of operations such as retrieval, group operation, processing, etc. Furthermore, since the data keeps increasing and the priority of data such as the age of data, usage frequencies becomes changing over time, it may require moving the stored data to another storage class based on data storing and processing costs. Therefore, an efficient method for policy-based autonomic data placement and movement is required in analytics platforms. However, most analytics platforms do not support the policy-based autonomic data management for improving cost-efficiency.

Various types of data are managed in data analytics platforms. Raw data may be collected from various sources, such as sensors, web, mobile devices, and log files. This raw data may need to be restructured based on specific purposes and then, analytics operations such as analytics algorithms, group operation and statistics may be applied to the restructured data to generate results. Restructured intermediate data (partially processed data) and result data (fully processed data) also require efficient management due to the size of the data, the amount of on-demand processing time, and the cost. For example, various data sources generate terabyte or petabyte amounts of data easily in a short time period and the generated data has to be analyzed in a reasonable time bound or in near real-time. Furthermore, even for the same raw data, different analytic algorithms and operations may generate various different intermediate data and results. This leads to accumulating a huge amount of data in addition to raw data. Therefore, it is critical to decide where to locate data appropriately and how to manage it. Most of the state-of-art data analytics platforms do not consider the data placement policy to efficiently use those data types.

Accordingly, there is a need for big data analytics providers and cloud service providers to achieve both the best cost efficiency and user satisfactions when managing very large amounts of data that may not be dealt with traditional data management methods.

### INCORPORATION BY REFERENCE

The following reference, the disclosure of which is incorporated herein by reference, in their entirety, is mentioned.

U.S. Pat. No. 4,974,156, issued Nov. 27, 1990, entitled MULTI-LEVEL PERIPHERAL DATA STORAGE HIERARCHY WITH INDEPENDENT ACCESS TO ALL LEVELS OF THE HIERARCHY, by Warren B. Harding, Robert D. Tennison, and William O. Vomaska.

U.S. Pat. No. 4,987,533, issued Jan. 22, 1991, entitled METHOD OF MANAGING DATA IN A DATA STORAGE HIERARCHY AND A DATA STORAGE HIERARCHY THEREFOR WITH REMOVAL OF THE LEAST RECENTLY MOUNTED MEDIUM, by Connie M. Clark, Warren B. Harding, Horace T. S. Tang.

### BRIEF DESCRIPTION

In one aspect, a method for autonomic data storage and movement includes calculating at least one cost associated with received data. In response to at least one calculated cost, the method includes determining a processing type associated with the received data and classifying the received data as one of a set of hierarchical storage classes in accordance with the determined processing type. The method further includes identifying a storage location associated with the one of the set of hierarchical storage classes in which the received data was classified. In addition, the method includes storing the received data in the identified storage location, wherein at least one of the calculating, classifying, identifying, and storing is performed with a computer processor.

In another aspect, a system for autonomic data storage and movement includes a data analytics platform. The data analytics platform includes a cost calculator configured to calculate a storing cost and a processing cost associated with received data, and a plurality of hierarchical storage locations, each storage location corresponding to a hierarchical storage class. The data analytics platform further includes memory which stores instructions for classifying the received data as one of the plurality of hierarchical storage classes, identifying a storage location associated with the one of the plurality of hierarchical storage classes, and storing the received data in the identified storage location. In addition, the data analytics platform includes a processor in communication with the memory which executes the instructions.

In another aspect, a computer-implemented method for autonomic data storage and movement includes determining a processing type associated with received data. The computer-implemented method further includes classifying the received data as one of a set of hierarchical storage classes in accordance with the determined processing type, and determining a priority associated with the received data in accordance with at least one priority metric. The computer-implemented method further includes storing the received data in storage location associated with the one of the set of hierarchical storage classes in accordance with a determined priority of the received data.

### BRIEF DESCRIPTION OF THE DRAWINGS

FIG. 1 is a block diagram of illustrating hierarchical storage classes for use in a system for autonomic data storage and movement in accordance with one aspect of the exemplary embodiment.

FIG. 2 is a functional block diagram of the system for autonomic data storage and movement in accordance with one aspect of the exemplary embodiment.

FIG. 3 is a flowchart that illustrates a method for autonomic data storage and movement in accordance with one aspect of the exemplary embodiment.

FIGS. 4A-4B is a flowchart that illustrates aspects of the method for autonomic data storage and movement according to an exemplary embodiment.

### DETAILED DESCRIPTION

One or more embodiments will now be described with reference to the attached drawings, wherein like reference numerals are used to refer to like elements throughout.

In accordance with one aspect, a system and method are provided for autonomic data placement and movement for increasing big data based on the priority of data and various costs. Data may include raw data to be processed, intermediate data to be generated and stored temporarily (i.e., recently processed data), and final result data. Accordingly, the method may provide a hierarchy of cloud storage classes, metrics to decide the priority of data and cost, and the policy to be applied to data placement and movement as a utility function to improve data processing and storage cost-efficiency. In various embodiments, the hierarchy of cloud storage classes may include 1) no data store, 2) memory, 3) HDFS, 4) database, 5) disk archive, 6) external clouds, and 7) data removal. The metrics to decide the priority of data and cost may include the type of applicable analytics services, the potential usage of data, usage frequency, the age of data, and the like.

As used herein, “No Data Store” hierarchical classification may indicate that storing data may cost more than re-processing the data in the future. With such a classification, data is not stored in local or cloud storage, but is re-processed whenever it is required.

“Memory” hierarchical classification may indicate the data is of high priority and expensive to re-process. As such, data in this classification may be stored locally.

“Hadoop Distributed File System (HDFS)” hierarchical classification may indicate that various analytics algorithms and operations may be applied on the data, e.g., the algorithms and operations are MapReduce types of jobs that require reading very large amounts of data, processing such data, and reducing results. HDFS corresponds to a distributed, scalable, and portable file system written in JAVA for the Hadoop framework. It will be appreciated that other file systems may be substituted herein for HDFS and the description herein referencing HDFS is for example purposes.

“Database” hierarchical classification may indicate intermediate data and results after application of analytics operations. For example, if column-wise or range based row-wise operations are frequently performed and the data is frequently retrieved, the data may be classified as database and stored in an associated database.

“Disk Archive” hierarchical classification may indicate data that no longer meets classification in HDFS or database classes, i.e., data having a lower priority than that of data of those classifications.

“External Cloud Storage” hierarchical classification may indicate data which requires more computation time than data transfer delay or intermediate data which has mainly a retrieval purpose. For example, data analytics platforms generally have limited storage resources, and may require more resources on-demand to store and process data. The classification of data with respect to external cloud storage may factor in data transfer overhead and data privacy, such that some data which does not have a privacy issue is stored in cloud storage.

“Data Removal” hierarchical classification may indicate data having the lowest priority when the cost to store data reaches a specified limit. In such circumstances, that lowest priority data may be removed from storage associated with the data analytics platform.

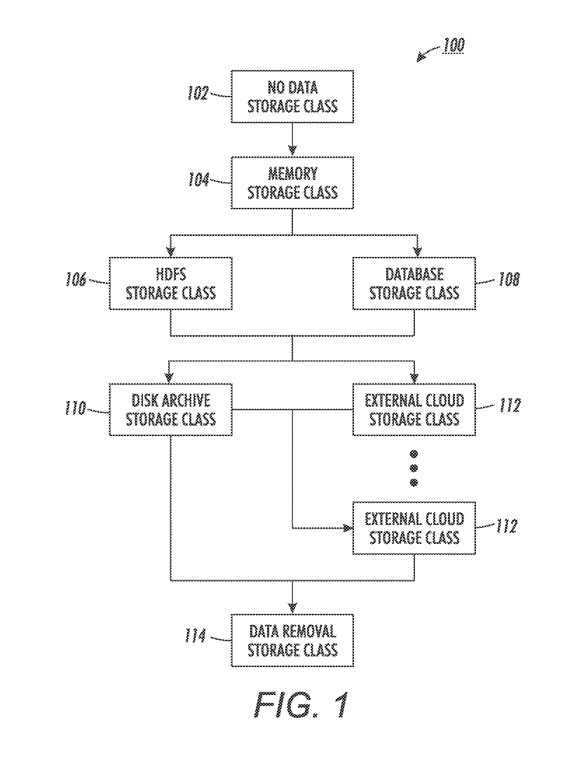

Referring now to FIG. 1, there is shown respective levels of hierarchical classes 100 utilized in accordance with one embodiment of the subject disclosure. As shown in FIG. 1, the classes 100 include the above-identified classifications, such as no data store 102, memory 104, HDFS 106, database 108, disk archive 110, external clouds 112, and data removal 114. In one embodiment, HDFS classification 106 and database classification 108 are in the same level in the hierarchy of storage classes 100, which may indicate that source data may be duplicated/placed in HDFS 106 and/or database 108 in a different format. For example, the source data may be placed in HDFS 106 as blocks for frequently processing MapReduce jobs, and an intermediate data from the same source data may be placed in database 108 for frequent retrieval and/or group operations.

In accordance with one aspect, the disk archive 110 and external clouds 112 may be in the same level in the hierarchy of storage classes 100. In such an aspect, the estimations of the data transfer delay and data computation time in the analytics platform (e.g., big-data analytics platforms) may be factored in determining whether data should be stored in the disk archive 110 or in the external clouds 112. According to one implementation, data may be stored in the external clouds 112 when no space remains in the disk archive 110. Furthermore, the subject systems and methods enable the determination of a specific cloud in the external clouds 112 in which to place the data, including when multiple different external clouds 112 each have variations in storage costs and data transfer delays. In some embodiments contemplated herein, data stored in HDFS 106 and database 108 may be replaced (i.e., moved) to the disk archive 110 or external clouds 112 in accordance with the priority of such data relative to new data, as discussed below. Similarly, data in the disk archive 110 or external clouds 112 may be removed (i.e., data removal 114) when available storage becomes limited, as discussed below.

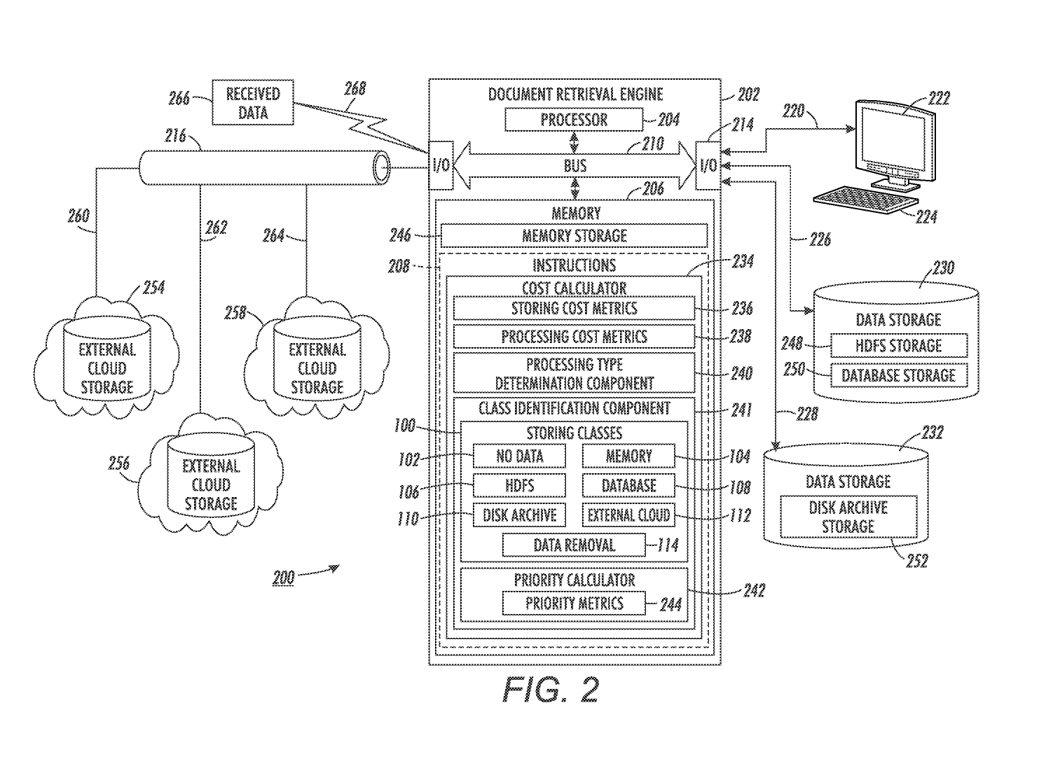

Turning now to FIG. 2, there is shown a functional block diagram of a system 100 for autonomic data storage and movement in accordance with one aspect of the subject disclosure. It will be appreciated that the various components depicted in FIG. 2 are for purposes of illustrating aspects of the exemplary embodiment, and that other similar components, implemented via hardware, software, or a combination thereof, are capable of being substituted therein.

As shown in FIG. 2, the autonomic data storage and movement system 100 includes a computer system represented generally as the data analytics platform 202, which is capable of implementing the exemplary method described below. It will be appreciated that while shown with respect to the data analytics platform 202, any suitable computing platform may be utilized in accordance with the systems and methods set forth herein. The exemplary data analytics platform 202 includes a processor 204, which performs the exemplary method by execution of processing instructions 208 which are stored in memory 206 connected to the processor 204, as well as controlling the overall operation of the data analytics platform 202.

It will be appreciated that while illustrated in FIG. 2 as implemented in a data analytics platform, the systems and methods set forth hereinafter are equally adaptable and contemplated to extend to any suitable data processing or storage system. For example, document management systems may utilize the systems and methods discussed hereinafter with respect to document storage and movement, file management systems relating to biological data or intensive modeling processes, and the like. Accordingly, it will be appreciated that myriad other environments are capable of utilizing the systems and methods now set forth.

The instructions 208 include a cost calculator 234, which includes storing cost metrics 236 and processing cost metrics 238. The cost calculator 234 may be configured to calculate or estimate the storing cost associated with data, either received data 266 (discussed below) or previously stored data. Estimation of the storing cost associated with data by the cost calculator 234 may be determined in accordance with the storing cost metrics 238. The storing cost metrics 238 may include, for example, the target storage cost and data transfer delay. The storage cost may be based upon a unit cost associated with the storage, that is, a monetary value per unit of storage, e.g., US dollar per 1 MB. The data transfer delay may be determined or ascertained via measurement of the delay taken to move data and corresponding bandwidth used. The storing cost metrics 238 may further include normalization of the storage cost and data transfer delay in estimating the storing cost associated with particular data.

The estimation of the processing cost associated with data by the cost calculator 234 may be made in accordance with the processing cost metrics 238. The processing cost metrics 238 may incorporate the computing node cost and corresponding processing time. Normalization of these costs may be performed by the cost calculator 234 in the estimation or computation of the processing cost associated with particular data. It will be appreciated that while the storage cost and the computing node cost are not often changed, the data transfer delay and data computation time can change over time. Accordingly, varying embodiments contemplated herein may apply different estimation techniques, e.g., time series analysis, queuing model, and data mining for predicting storing cost and processing cost. Thus, the systems and methods set forth herein are not limited to any such specific estimation technique.

The instructions 208 of memory 206 may further include a processing type determination component 240 configured to determine the type of processing associated with received data 266 or previously stored data (not shown). The processing types, e.g., analytics algorithms, statistical operations, and the like, may be given by users or predicted by analyzing data types, user preferences, or previous usages on similar types of data in terms of structure e.g., text, semi-formatted, formatted, and the like, and context e.g., same domain such as financial, healthcare, TWITTER, FACEBOOK, and the like. The type of processing associated with data, as determined by the processing type determination component 240, may be utilized by a class identification component 241, as discussed below.

The class identification component 241, depicted in the instructions 208 of memory 206, is configured to determine the storage class 100 in which received data 266 stored. The class identification component 241 may further be configured to determine into which storage class 100 previously stored data should be moved, as discussed in greater detail below. The storage class 100 into which data 266 should be stored may be determined in accordance with the type of data, the type of processing associated with the data, and the like. For example, HDFS 106 will be a proper storage class 100 if the processing type is MapReduce type of job, and database 108 will be a proper storage class 100 if the processing type is column-wise or range based row-wise operation, or the data can be stored on both HDFS 106 and database 108 if the processing type is applicable for both storage classes 100. In accordance with varying embodiments contemplated herein, the mapping between processing type and appropriate storage class 100 may be predefined or obtained by analyzing previous usages, i.e., where previously received data of the same processing type was classified. It will be appreciated that since the size of memory storage 246 is typically much smaller than HDFS storage 248 or database storage 250, the data that is highly prioritized (as discussed below) can be selected to be classified in the memory storage class 104 and thus stored in the memory storage 246.

The instructions 208 may further include a priority calculator 242 that is configured to calculate or determine a priority associated with particular data, i.e., received data 266 or previously stored data. In one embodiment, such priority calculations are performed upon a determination that the storage location 246-258 corresponding to the storage class 100 in which the data was classified lacks sufficient capacity to store the data. In such an embodiment, the priority calculator 242 may be initiated to ascertain the respective priority of the new data for the class 100, as well as the priority of the data already stored in the location 246, 248, 250, 252, 254, 256, or 258 associated with that class 100. For example, the priority of particular data may be used to determine the appropriate storage class 100, with data having a higher priority stored in a faster/more accessible storage location, e.g., memory storage 246, HDFS storage 248, and so forth, and data having a lower priority, i.e., data infrequently used, stored in disk archive storage 252 or external cloud storage 254, 256, 258, as discussed more fully below.

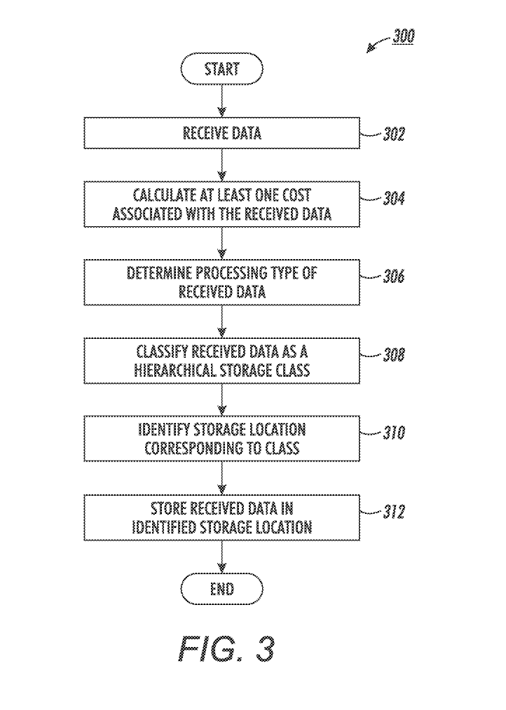

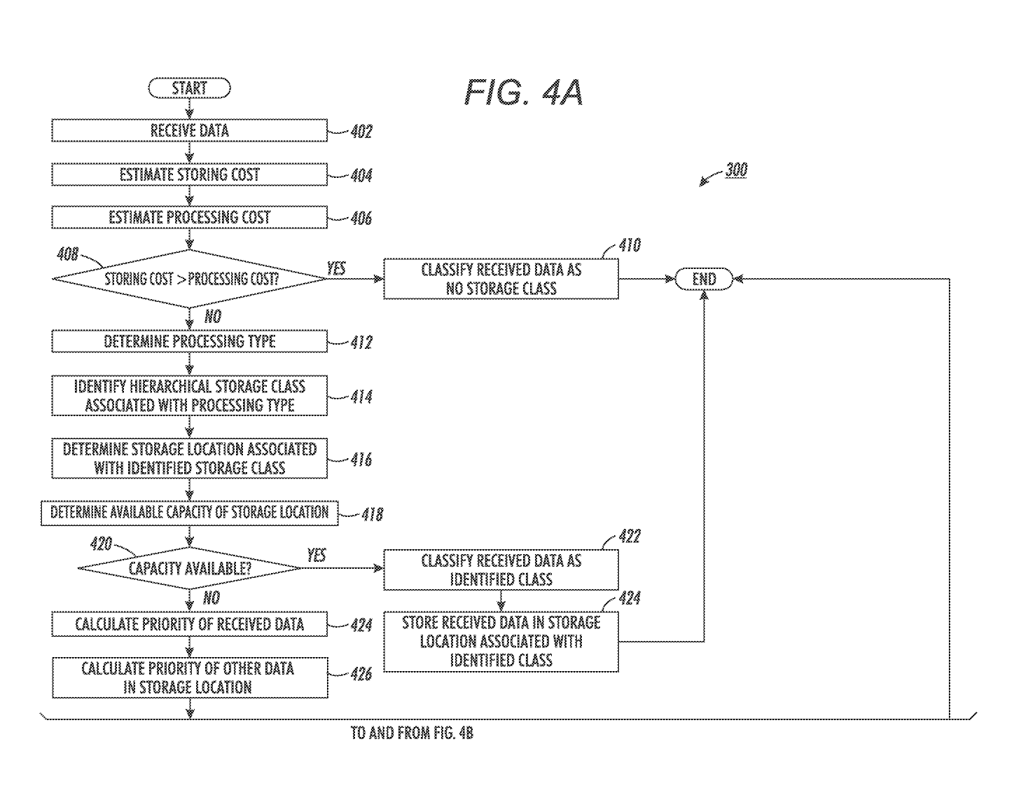

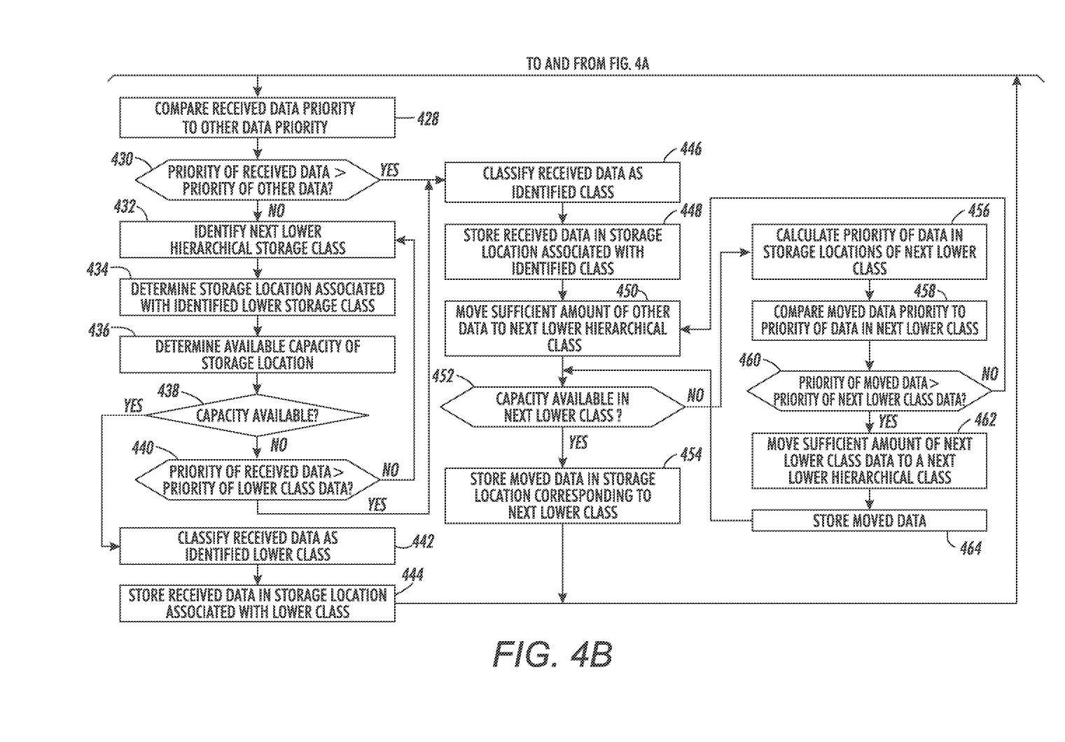

In accordance with one embodiment, when a storage location 246-258 has insufficient capacity to store received data 266 that has been classified into the corresponding storage class 100, the priority associated with the received data 266 (or data moved) is determined along with the respective priorities of all other data in that storage class location 246-258. The higher priority data is then stored in the corresponding storage class location 246-258, and a sufficient amount of lower priority data in that storage class 100 is reclassified, i.e., moved to the next lower class 100, as explained in greater detail below with respect to FIGS. 3-4.

The priority calculator 242 may be configured to utilize priority metrics 244 in determining the priority of particular data. The priority metrics 244, may include potential usage of data (e.g., linkage to analytics algorithms and operations, predicted usage by user preferences, degree of sharing among different users, and the like), data privacy components, frequency of usages, age of the data, and the like. The various priority metrics 244 utilized in calculating the priority of data are discussed more fully below with respect to FIGS. 3 and 4.

The data analytics platform 202 may include one or more input/output (I/O) interface devices 212 and 214 for communicating with external devices. The I/O interface 214 may communicate, via communications link 220, with one or more of a display device 222, for displaying information, such estimated destinations, and a user input device 224, such as a keyboard or touch or writable screen, for inputting text, and/or a cursor control device, such as mouse, trackball, or the like, for communicating user input information and command selections to the processor 204.

The data analytics platform 202 may include a computer server, workstation, personal computer, cellular telephone, tablet computer, pager, combination thereof, or other computing device capable of executing instructions for performing the exemplary method.

According to one example embodiment, the data analytics platform 202 includes hardware, software, and/or any suitable combination thereof, configured to interact with an associated user, a networked device, networked storage, remote devices, or the like.

The memory 206 may represent any type of non-transitory computer readable medium such as random access memory (RAM), read only memory (ROM), magnetic disk or tape, optical disk, flash memory, or holographic memory. In one embodiment, the memory 206 comprises a combination of random access memory and read only memory. In some embodiments, the processor 204 and memory 206 may be combined in a single chip. The network interface(s) 212, 214 allow the computer to communicate with other devices via a computer network, and may comprise a modulator/demodulator (MODEM). Memory 206 may store data the processed in the method as well as the instructions for performing the exemplary method.

The digital processor 204 can be variously embodied, such as by a single core processor, a dual core processor (or more generally by a multiple core processor), a digital processor and cooperating math coprocessor, a digital controller, or the like. The digital processor 204, in addition to controlling the operation of the data analytics platform 202, executes instructions 208 stored in memory 206 for performing the method outlined in FIGS. 3-4.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

The various components of the data analytics platform 202 associated with system 100 may all be connected by a data/control bus 210. The processor 204 of the platform 202 is in communication with associated data storage devices 230 and 232 via respective communication links 226 and 228. Suitable communications links 230-232 may include, for example, the public switched telephone network, a proprietary communications network, infrared, optical, or other suitable wired or wireless data communications. The data storage devices 230-232 are capable of implementation on components of the data analytics platform 202, e.g., stored in local memory 206, i.e., on hard drives, virtual drives, or the like, or on remote memory accessible to the data analytics platform 202.

The associated data storage devices 230-232 correspond to any organized collections of data used for one or more purposes. Implementation of the associated data storage devices 230-232 is capable of occurring on any mass storage device(s), for example, magnetic storage drives, a hard disk drive, optical storage devices, flash memory devices, or a suitable combination thereof. As illustrated in FIG. 2, the data storage device 230 may include HDFS storage 248 and database storage 250 thereon. That is, the data storage device 230 may include storage areas 248 and 250 for respectively storing data classified as HDFS storage class 106 and database storage class 108 by the class identification component 241. The data storage device 232 may include a disk archive storage area 252 representing the storage location of data classified in the disk archive storage class 110 by the class identification component 241.

It will be appreciated that the autonomic data storage and movement system 200 is capable of implementation using a distributed computing environment, such as a computer network 216, which is representative of any distributed communications system capable of enabling the exchange of data between two or more electronic devices. It will be further appreciated that such a computer network includes, for example and without limitation, a virtual local area network, a wide area network, a personal area network, a local area network, the Internet, an intranet, or the any suitable combination thereof. Accordingly, such a computer network comprises physical layers and transport layers, as illustrated by various conventional data transport mechanisms, such as, for example and without limitation, Token-Ring, Ethernet, or other wireless or wire-based data communication mechanisms. Furthermore, while depicted in FIG. 2 as a networked set of components, the system and method are capable of implementation on a stand-alone device adapted to perform the methods described herein.

The data analytics platform 202 may be in data communication with the network 216 via a communications link 218 with the I/O interface 212. A suitable communications link 218 may include, for example, the public switched telephone network, a proprietary communications network, infrared, optical, or other suitable wired or wireless data transmission communications. The system 200 may further include one or more external cloud storage components 254, 256, and 258, as illustrated in FIG. 2. The cloud storage components 254-258 may be coupled to the computer network 216 via respective communications links 260, 262, and 264. Suitable communications links 260-262 may include, for example and without limitation, the public switched telephone network, a proprietary communications network, infrared, optical, or other suitable wired or wireless data transmission communications, etc. In accordance with one embodiment, each cloud storage component 254-258 may be located in different locations, have different data transfer delays, different bandwidth capabilities, different storage capacities, different security protocols, different service providers, and the like.

In one embodiment, data 266 is received via a communications link 268 from any suitable source. The received data 266 may be raw data, intermediate data (partially processed), or the like. In some embodiments, the received data 266 may comprise raw data, collected from various sources, e.g., sensors, the Internet, mobile devices, log files, image files, biological files, and the like. The received data 266 may constitute intermediate data generated via different analytic algorithms from raw data or previously processed intermediate data. The received data 266 may further include results data representative of fully processed raw data or intermediate data. In some embodiments, the received data 266 may be raw data that must be restructured (i.e., intermediate data) based on specific purposes and then, analytics operations such as analytics algorithms, group operation and statistics may be applied to the restructured data to generate results.

The received data 266 is first analyzed to determine whether it should be stored or not. That is, the cost calculator 234 determines the storing cost and the processing cost associated with the data using the aforementioned metrics 236 and 238. If the storing cost is more than the processing cost, the data is identified by the class identification component 241 as belonging in the no data storage class 102, and the data is ignored by the data analytics platform 202. That is, if the cost for storing the received data 266 is greater than the cost that would incur as a result of re-processing the data 266, it is more efficient to not store the received data 266 and simply re-process it at a later time when needed. However, in the event that the processing cost associated with the received data is greater than the cost for storing the received data 266, the processing type determination component 240 is implemented by the processor 204 to determine the type of processing associated with the received data 266.

As discussed above, the type of processing associated with the received data 266 can be used to identify where other data of the same processing type were stored. Alternatively, the type of processing associated with the received data 266 may be associated with a type of storage, i.e., intensive processing applications may require faster storage, less intensive processing or applications may be able to use slower storage. Other factors may be utilized to determine the appropriate storage class 100 for received data 266, as discussed above with respect to the class identification component 241. Once the class identification component 241 has identified one of the hierarchical storage classes 100, i.e., no data storage class 102, memory storage class 104, HDFS storage class 106, database storage class 108, disk archive storage class 110, external cloud storage class 112, or data removal storage class 114 for the received data 266, the storage location 246-258 associated with the identified class 100 is analyzed to determine whether that storage location 246-258 has sufficient capacity available to store the received data 266. In the event that sufficient capacity exists, the received data 266 is suitably stored in that corresponding storage location 246-258.

In the event that sufficient capacity is not available in the storage location 246-258 corresponding to the class 100 of the received data 266, the respective priorities of the received data 266 and data already stored in that location 246-258 are calculated. Calculation of the priority via the priority calculator 242 is discussed briefly above and in greater detail below with respect to FIGS. 4A-4B. After determining the respective priorities of the received data 266 and the data already present in the storage location 246-258, the data (received 266 or previous) having the higher priority is allotted to remain in or be stored in that storage location 246-258. A sufficient amount of lower priority data (if the received data 266 is of higher priority) is reclassified as the next lower class (i.e., reclassified from memory class 104 to HDFS class 106, etc.) and moved to the storage location 246-258 corresponding to that next lower class 104-114. This process is repeated with respect to the moved data (priority calculations of the moved data and data already present in the next lower class storage location 246-258) until sufficient capacity is available for storing all data, or a sufficient amount of data has been reclassified as data removal class 114 and removed from storage. The same process may be performed with respect to the received data 266 when it is determined to have a lower priority than the data already stored in the storage class. In this manner, large amounts of data are capable of being effectively and efficiently managed across a plurality of storage locations, with each storage location capable of having disparate capabilities with respect to capacity, speed, and the like.

Turning now to FIG. 3, there is provided an overview of the exemplary method 300. The method 300 begins at 302, whereupon data 266 is received, such as raw data, intermediate data, results, or the like. At 304, a cost, such as storing cost and a processing cost are calculated via the cost calculator 234 or other suitable component associated with the platform 202. At 306, a processing type associated with the received data 266 is determined via the processing type determination component 240 or other suitable component associated with the system 200 in response to the calculated costs. In accordance with one embodiment, the processing type is determined when the processing cost is greater than the storing cost, as discussed above and in greater detail below.

At 308, the received data 266 is classified as one of a set of hierarchical storage classes 104-114 based upon the determined processing type. A storage location 246-258 associated with the classification is then identified at 310. The received data 266 is then stored in the identified storage location 246-258 at 312.

Turning now to FIGS. 4A-4B, there is provided a detailed illustration of the exemplary method 400. The method 400 begins at 402, whereupon data 266 is received by a computer system, for example, the data analytics platform 202. It will be appreciated that the method 400 may be implemented by a server (not shown) in communication with the data analytics platform 202, which is configured to provide the data analytics platform 202 with the storage and additional processing as discussed above. After receipt of the data 266, a storing cost associated with the data 266 is estimated at 404. That is, the cost calculator 234, in accordance with the cost metrics 236 discussed above, calculates or otherwise estimates a cost associated with storing the received data 266. The cost calculator 234 then estimates the processing cost associated with the received data 266 at 406. As discussed in greater detail above, the cost calculator 234 may utilize the processing cost metrics 236 to ascertain a cost that would be incurred in processing the received data 266.

A determination is then made at 408 whether the storing cost is greater than the processing cost. That is, whether it will cost more to store the data than it will to process the data again. Upon a positive determination at 408, operations proceed to 410, whereupon the received data 266 is classified as no data storage class 102. Thereafter, the data is not stored, as it would be less expensive to simply reprocess the data rather than store it, and operations with respect to FIGS. 4A-4B terminate.

Upon a determination at 408 that the processing cost is greater than the storing cost, operations progress to 412. At 412, the processing type determination component or other suitable component of the system 200 determines the processing type associated with the received data 266. As discussed above, determination of the processing type may be made in accordance with previous determinations associated with similar data, or the like. At 414, the hierarchical storage class 100 associated with the determined processing type is identified via the class identification component 241 or other suitable component associated with the system 200. That is, the received data 266 is identified as potentially belonging to the memory storage class 104, HDFS storage class 106, database storage class 108, disk archive storage class 110, external cloud storage class 112, or data removal class 114.

At 416, the storage location 246-258 corresponding to the identified class 104-114 is determined. For example, when the received data 266 is identified as belonging to the HDFS storage class 106, the location associated with HDFS storage 248 is identified. Similarly, if the received data 266 is classified as memory class 104, the memory storage location 246 is determined. The available capacity corresponding to the determined storage location 246-258 is then determined at 418. That is, a determination is made as to the amount of free space at the storage location 246-258 (i.e., disk space, RAM space, etc.) corresponding to the identified storage class 104-114 that is available for storing received data 266.

A determination is then made at 420 whether there is enough capacity available at the determined storage location 246-258 to store the received data 266. That is, the size (KB, MB, GB, TB, etc.) of the received data 266 is compared to the available free space in the storage location 246-258. Upon a positive determination at 420, operations proceed to 422, whereupon the received data 266 is classified as the identified storage class 104-114. At 424, the received data 266 is stored in the storage location 246-258 corresponding to the storage class 104-114 in which the received data 266 was classified. Thereafter, operations of FIGS. 4A-4B with respect to the received data 266 terminate as shown.

Returning to 420, upon a determination that sufficient capacity is not available in the storage location 246-258 corresponding to the identified storage class 104-114, operations proceed to 424. At 424, the priority associated with the received data 266 is calculated. In accordance with one embodiment, the priority may be calculated utilizing the priority metrics 244 stored in instructions 208 of memory 206. That is, the priority metrics 244 are retrieved from memory 206 and used by the priority calculator 242 to calculate the priority of the received data 266. The metrics 244 may include determining the potential usage of the received data 266, such as the linkage of the received data 266 to analytics algorithms and operations. For example, there be various analytics algorithms (e.g., clustering algorithms, sentiment analysis, text analysis, etc.) and group operations or statistical operations (e.g., average, count, summation, etc.). Each analytics algorithm or operation may be applicable to a certain type of data unit. For example, text analysis can be applicable only to the text type of data unit and average can be applicable only to number data unit, etc. Among the analytics algorithms and operations, some of them may be frequently used than others. From the analysis of historical usage, the frequently used analytics algorithms or operations can be specified as well as the relevant data unit where the analytics algorithms or operations are applied. Then, the data unit which has the higher probability to be accessed by frequently used analytics algorithms or operations should have higher potential usage.

The potential usage of the received data 266 may further be ascertained via the user preferences. That is, users may clearly indicate their preferences for analytics algorithms or operations on certain data units. Also, from the analysis of historical usage for each individual user, the usage preferences of users may be analyzed. It will be appreciated that as this usage preference increases the chance of access for a data unit, the data units which have higher user preferences should have higher priority. The potential usage may also include the degree of sharing among different users. The data, including intermediate data and results as well as raw data, can be shared among multiple users. For example, different users may want to apply different analytics algorithms but on the same source data, which causes multiple users share the raw data but generate different results. Additionally, different users may want to apply the same analytics algorithm on the same or overlapped raw data, which makes multiple users share the data. The more users share a data unit, the higher the priority of data should be.

In accordance with one embodiment, the potential usage of the received data 266 for the data unit i at time t, pᵢ(t), may be calculated as:

pᵢ(t)=Lᵢ(t)+Pᵢ(t)+Sᵢ(t) equation (1)

where Lᵢ(t) is the number of analytics algorithms and operations which can be applicable to the data unit i, Pᵢ(t) is the number of links indicated by user preferences, and Sᵢ(t) is the number of shares by users.

The priority metrics 244 may further include data privacy factors. It will be appreciated that some business domain data is private so that it is restricted from being placed in external clouds, (e.g., customers secure information such as social security number, address, etc.), or business critical data, and so forth. Accordingly, this private data should be kept inside of the data center even though other factors have low priority indicating data movement. The data privacy can be set high enough to maintain private data in a certain level of the storage hierarchy 100, for example, HDFS storage class 106, database storage class 108, or disk archive storage class 110.

The priority metrics 244 may also include frequency of usage factors, such that from the historical usages of the data, the frequency of usages for each data unit is analyzed. It is monitored for a period of time from the monitoring time t. In addition, the priority metrics 244 may include the age of the data, such that recently used data has a higher priority than old data if other metrics have the same priority. Some data which is not used for a long time will eventually be moved to the next level of storage class and be removed.

In one embodiment, the priority of received data 266 is calculated at 424 may be as follows:

$${φ}_{i} ( t ) = α {p}_{i} ( t ) \times {P}_{i} \times C ( {S}_{data} , {T}_{proc} ) \times β \frac{fi ( t )}{T} \times γ \frac{1}{( t - ti )} \\ C ( {S}_{data} , {T}_{proc} ) = {aC}_{nw} {S}_{data} + {bC}_{strg} {S}_{data} + {cC}_{comp} {T}_{comp} , \qquad equation ( 2 )$$

where the first term is potential usage of data, the second term is privacy degree of data, the third term is estimated cost, the fourth term is frequency of usages, and the fifth term is age of data, and all of terms are normalized. The pᵢ(t) is the number of potential accesses for data unit i as in equation (1), fᵢ(t) is the number of accesses for data unit i, T is monitoring time period [t_{K}, t] where t is current time and t_{K}<t, tᵢ is the latest time of usage for data unit i. C(S_{data}, T_{proc}) is the estimated cost depending on data size, S_{data} and processing time, T_{proc}. The first term of cost equation is data transfer cost, the second term is storing cost, and the third term is computing cost. C_{nw}, C_{strg}, and C_{comp} are network unit cost, storage unit cost, and computing unit cost respectively. α, β, γ, a, b, and c are normalizing factors.

The priority of the other data already present in the determined storage location 246-258 is then calculated at 426, and the calculated priorities of the received data 266 and the other data is compared at 428. A determination is then made at 430 whether the priority of the received data 266 is greater than the priority calculated for the previous data stored in the determined storage location 246-258 corresponding to the identified hierarchical storage class 100.

Upon a determination at 430 that the received data 266 has a lower priority than that of the other data already in the storage location 246-258 associated with the identified storage class 104-114, operations proceed to 432. At 432, the next lower hierarchical storage class 104-144 than that of the identified storage class 104-114 is identified. That is, if the received data 266 had initially be identified with the memory storage class 104 and sufficient capacity in the memory storage location 246 was not available, the relative priority of the received data 266 is compared to the priority of data already stored in the memory storage location 246. When that other data is of higher priority than that of the received data 266, the next lower class, i.e., the HDFS storage class 106 is identified with respect to the received data 266.

Returning to 434, the storage location 246-258 corresponding to the next lower identified hierarchical storage class 104-114 is determined. The available capacity associated with that storage location 246-258 is then determined at 436. A determination is then made at 438 whether sufficient capacity is available in the storage location 246-258 of the next lower hierarchical storage class 104-114 to store the received data 266. In the event that sufficient storage space is free, i.e., available, operations proceed to 442, whereupon the received data 266 is classified as the next lower hierarchical storage class 104-114 and is stored, at 444, in the storage location 246-258 associated with the next lower hierarchical class 104-114 in which the received data 266 is classified. Operations with respect to the received data in FIGS. 4A-4B terminate thereafter.

Upon a determination at 438 that available capacity is not sufficient to store the received data 266 in the storage location 246-258 associated with the next lower class 104-114, operations proceed to 440, whereupon a determination is made whether the priority of the received data 266 is greater than the priority of the other data already stored in the next lower hierarchical storage class 104-114. That is, the priorities of the received data 266 and the data stored in the next lower hierarchical storage class 104-114 are calculated via the priority calculator 242 utilizing the priority metrics discussed above and subsequently compared to each other. Upon a determination that the priority of the received data 266 is higher than the priority of the other data of the next lower storage class 104-114, operations proceed to 446, whereupon the received data 266 is classified as the identified class. The received data 266 is then stored in the storage location 246-258 corresponding to the storage class 104-114 at 448. At 450, a suitable portion of other data having lower priority than that of the received data 266 is moved so as to make room for the received data 266 being stored in its place. It will be appreciated that while illustrated as occurring first, the storage of the received data 266 may occur as other data is being moved, after the other data has been moved, or the like, and the illustration in FIGS. 4A-4B of the relative positions of these operations is for example purposes. Operations then proceed to 452 as set forth below.

Returning to 430, upon a determination that the priority of the received data 266 is greater than that of the other data in the initial storage 246-258 of the identified class, or upon a determination at 440 that the priority of the received data 266 is greater than that of the other data in the next lower storage class 104-114, operations proceed to 446, whereupon the received data is classified as the identified class 104-114 and stored in the corresponding location 246-258 at 448 as discussed above. A suitable amount of data of lower priority than that of the received data 266 is then moved to the next lower hierarchical class 104-114 at 450, as discussed above.

At 452, a determination is made whether there is sufficient capacity in the storage location 246-258 of the next lower hierarchical class 104-114 to accept storage of the moved data. Upon a positive determination at 452, operations proceed to 454, whereupon the moved data is stored in the storage location 246-258 corresponding to the next lower hierarchical class. Upon a determination at 452 that sufficient capacity is not available, operations proceed to 456, whereupon the priority of the data stored in the storage location 246-258 of a next lower hierarchical class 104-114 is calculated. The relative priorities of the moved data and the data in the next lower hierarchical storage 246-258 are compared at 458 and a determination is made at 460 whether the priority of the moved data is greater than that of the data already in the next lower hierarchical storage location 246-258.

Upon a determination at 460 the priority of the moved data is not greater than the priority of the data already in the next lower storage class 104-114, operations return to 450, whereupon it is moved to the next lower storage class 104-114 and operations continue thereafter as set forth above. Upon a determination at 460 that the priority of the moved data is greater than the data already in the storage location 246-248 of the next lower hierarchical class 104-114, operations proceed to 462. At 462, a sufficient amount of data is moved from the next lower hierarchical class 104-114 to the next lower class 104-114 after it. The original moved data is then stored in the storage location 246-258 that now has sufficient capacity. Operations then proceed to 452, whereupon the capacity available in the next lower hierarchical class storage location 246-258 is analyzed to determine whether there is room for the most recently moved data. Operations then continue as set forth above until all data has been stored or removed from the system 200.

Thus, for example, if the received data 266 had been identified as belonging to the memory storage class 104, but the corresponding storage location 246 lacked sufficient capacity and the priority of the received data 266 was less than the priority of data already in the memory storage 246, the next lower class, i.e., HDFS class 106 was analyzed (storage capacity and priority). If the received data 266 had higher priority, then a portion of data in HDFS storage 248 would be moved to the next lower class 108, database storage location 250. If that location 250 lacked sufficient capacity, priority calculations would be performed to determine which had higher priority, the data stored in database location 250 or the moved data. If the moved data had higher priority, it would be classified as belonging to the database storage class 108 and stored in location 250, while a suitable amount of data already in location 250 would be moved to the next storage class, i.e., disk archive class 110. Calculations would then be performed relative to the moved data and the data already in the disk archive storage 252. This process would be repeated until all data was stored, i.e., in cloud storage 254-258, or would be repeated until some data had been classified as data removal 114 and removed. In accordance with one embodiment, the storage in cloud storage 254-258 of data may select amongst the cloud storage 254-258 based upon respective retrieval times, delays, storage capacities, and the like.

Thus, the systems and methods set forth herein evict the lowest priority data first and move it to the next lower level of storage class. For example, the evicted data from HDFS 106 or database 108 will be moved to the disk archive 110, and the evicted data from disk archive 110 will be moved to external clouds 112. The data evicted from external clouds 112 will eventually be removed unless the priority of data increases for a long time.

The method illustrated in FIGS. 3-4B may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in FIGS. 3-4B, can be used to implement the method for crowdsourcing a transportation network.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for autonomic data storage and movement, comprising:
calculating at least one cost associated with received data;
responsive to at least one calculated cost, determining a processing type associated with the received data;
classifying the received data as one of a set of hierarchical storage classes in accordance with the determined processing type;
identifying a storage location associated with the one of the set of hierarchical storage classes in which the received data was classified; and
storing the received data in the identified storage location,
wherein at least one of the calculating, classifying, identifying, and storing is performed with a computer processor.

2. The method of claim 1, wherein calculating the at least one cost further comprises:
estimating a storing cost associated with storage of the received data; and
estimating a processing cost associated with processing of the received data, wherein the received data is classified in a no storage hierarchical storage class when the estimated storing cost is greater than the estimated processing cost.

3. The method of claim 2, wherein estimating the storing cost includes calculating a storage cost and a data transfer delay, and wherein estimating the processing cost includes calculating a computer node cost and a computation time.

4. The method of claim 3, further comprising:
determining a capacity associated with the identified storage location; and
responsive to determining a sufficient capacity, storing the received data in the identified storage location.

5. The method of claim 4, further comprising:
calculating a priority of the received data responsive to determining an insufficient capacity of the identified storage location;
calculating a priority of data in the identified storage location; and
storing the received data in accordance with a comparison of the priority of the received data and the priority of the data in the identified storage location.

6. The method of claim 5, further comprising moving the data in the identified storage location to a storage location associated with a next lower hierarchical class responsive to the priority of the received data being greater than the priority of the data in the identified storage location.

7. The method of claim 5, further comprising:
identifying a storage location associated with a next lower hierarchical class responsive to the priority of the received data being less than the priority of the data in the identified storage location;
classifying the received data as the next lower hierarchical class; and
storing the received data in the storage location associated with the next lower hierarchical class.

8. The method of claim 7, wherein the hierarchical storage class is selected from the group consisting of no data storage class, memory storage class, HDFS storage class, database storage class, disk archive storage class, external cloud storage class, and data removal storage class.

9. The method of claim 5, wherein the priority is calculated in accordance with a type of applicable analytics services, a potential usage of the received data, a usage frequency, and an age of the received data.

10. The method of claim 9, wherein determining a processing type is determined in accordance with at least one of a data type, a user preference, and a previous usage of a similar data type.

11. A system for autonomic data storage and movement, comprising:
a data analytics platform, including:
a cost calculator configured to calculate a storing cost and a processing cost associated with received data;
a plurality of hierarchical storage locations, each storage location corresponding to a hierarchical storage class;
memory which stores instructions for:
classifying the received data as one of the plurality of hierarchical storage classes,
identifying a storage location associated with the one of the plurality of hierarchical storage classes, and
storing the received data in the identified storage location; and
a processor in communication with the memory which executes the instructions.

12. The system of claim 11, wherein the cost calculator includes at least one storing cost metric and at least one processing cost metric.

13. The system of claim 12, wherein the memory further stores instructions for:
estimating a storing cost associated with storage of the received data in accordance with the at least one storing cost metric; and
estimating a processing cost associated with processing of the received data in accordance with the at least one processing cost metric, wherein the received data is classified in a no storage hierarchical storage class when the estimated storing cost is greater than the estimated processing cost.

14. The system of claim 13, wherein estimating the storing cost includes calculating a storage cost and a data transfer delay, and wherein estimating the processing cost includes calculating a computer node cost and a computation time.

15. The system of claim 14, wherein the memory further stores instructions for:
determining a processing type associated with the received data in accordance with at least one of a data type, a user preference, and a previous usage of a similar data type; and
classifying the received data in accordance with the determined processing type.

16. The system of claim 15, further comprising:
a priority calculator configured to calculate a priority associated with the received data and data stored in the plurality of hierarchical storage locations;
wherein the memory further stores instructions for:
calculating a priority of the received data responsive to determining an insufficient capacity of the identified storage location,
calculating a priority of data in the identified storage location, and
storing the received data in accordance with a comparison of the priority of the received data and the priority of the data in the identified storage location.

17. The system of claim 16, wherein the priority is calculated in accordance with a type of applicable analytics services, a potential usage of the received data, a usage frequency, and an age of the received data.

18. A computer-implemented method for autonomic data storage and movement, comprising:
determining a processing type associated with received data;
classifying the received data as one of a set of hierarchical storage classes in accordance with the determined processing type;
determining a priority associated with the received data in accordance with at least one priority metric; and
storing the received data in storage location associated with the one of the set of hierarchical storage classes in accordance with a determined priority of the received data.

19. The computer-implemented method of claim 18, further comprising:
determining a capacity of the storage location relative to a size of the received data;
comparing the determined priority of the received data with a priority of data already in the storage location; and
moving the received data or the data already in the storage location to a storage location associated with a next lower hierarchical storage class in accordance with a result of the priority comparison.

20. The computer-implemented method of claim 19, wherein the priority is determined in accordance with a type of applicable analytics services, a potential usage of the received data, a usage frequency, and an age of the received data.
